(19) United States
(12) Patent Application Publication
(10) Pub. No.: US 2011/0091713 A1
(43) Pub. Date: Apr. 21, 2011

(54) Fire Resistant Composite Panel

(76) Inventors: Douglas J. Miller, North Olmstead, OH (US); Mark Segger, Strongville, OH (US); Yevgeniy Pavlovich Griffin, Macedonia, OH (US)

(21) Appl. No.: 11/565,169

(22) Filed: Nov. 30, 2006

Related U.S. Application Data
(63) Continuation-in-part of application No. 11/314,975, filed on Dec. 21, 2005, now abandoned.

(51) Int. Cl. C09K 21/02; B32B 5/18

(52) U.S. Cl. 428/312.2; 252/601

(57) ABSTRACT

A composite panel, which includes a heat spreading layer and a carbon foam core having desirable fire retardant properties, and resistance to environmental stress. The composite panel can also include a first layer and a second layer bound to a first surface and second surface of the carbon foam core. Applications of the panel include structural and fire retardant elements of residential and commercial buildings, aircraft and watercraft.

This application is a continuation in part of U.S. patent application Ser. No. 11/314,975, filed Dec. 21, 2005, entitled CARBON FOAM STRUCTURAL INSULATED PANEL, the details of which are incorporated herein by reference.

### BACKGROUND OF THE INVENTION

1. Technical Field

The present invention relates to high strength, fire resistant composite panels useful for applications including the construction of roofs, floors, walls, doors, elevator shafts, columns, and other structures where a high strength-to-density ratio and improved fire resistance characteristics are useful. Moreover, the inventive composite panels exhibit improved shielding from electromagnetic interference (EMI), making them especially useful in environments where electronics need to be shielded from the effects of electromagnetic interference. More particularly, the present invention relates to the use of carbon foam with an insulating R value of about 3 per inch (meaning that, for every inch in thickness, the carbon foam has an R value of 3; thus, a six inch thick foam block has an R value of 18) combined with a heat spreading layer in structural insulated panels which are highly resistant to fire, heat, moisture, and other environmental stresses while maintaining a high compressive strength.

2. Background Art

Many residential units' structures are built with a combination of lumber materials and metal nails. After construction of the structural frame, an insulating material such as fiberglass insulation is installed to control thermal conduction between the exterior of the residence and the interior. Also, interior paneling, often comprising gypsum board, is used to maintain the placement of the fiberglass insulation between the exterior wall and the interior surface. While this type of building structure is well understood and possesses adequate strength, this approach is both slow and labor intensive. Furthermore, these structures maintain poor insulation and resistance to environmental stresses such as moisture or insects. As such, structural insulated panels (SIPs) have been gaining popularity for use as structural building materials. Essentially, outer high-strength layers are attached to an insulating inner layer, creating a sandwich layer possessing both strength and insulating properties.

For a fire to start, the three elements of fuel, oxygen, and an ignition source are required. Fires rarely start within a SIP due to the very limited oxygen supply present, so the primary threat is from a fire started outside of a panel. Such a fire will heat the outside surface to the point where delamination causes the insulation to withdraw from the hot surface, creating an air gap within the panel. The temperature continues to rise to the point where the insulation auto-ignition temperature is reached, and a fire begins to burn within the panel. This core fire causes delamination in adjacent areas, and the fire rapidly spreads. As the insulation core is consumed, the panels lose their rigidity and collapse, further exposing the core insulation and propagating the fire. The exterior surfaces hinder fire fighting efforts by preventing water from reaching the burning inner core, and significant fire losses result. Any puncture of the exterior surface before a fire exposes the core more rapidly, enhancing the threat.

Prior attempts to develop SIPs include the disclosure of Smith, in U.S. Pat. No. 4,163,349, which discloses an insulated building, though without adequate thermal insulating properties.

In Hardcastle et al. (U.S. Pat. No. 4,425,396) an insulating panel is disclosed with a synthetic organic polymeric foam with protective weathering layers comprised of multiple thermoplastic sheets.

Cahill (U.S. Pat. No. 6,656,858) describes a lightweight laminate wall comprised of a low density layer of from about 0.5 to 3 pounds per cubic foot and a second, reinforcing layer of a polymeric fabric. These structures are lightweight, have a low moisture resistance and meet building code requirements regarding transverse wind loading.

Porter (U.S. Pat. No. 6,599,621) describes a SIP with high strength and resistance to fire and particularly to water and changes in humidity. The disclosed structures are comprised of an inner insulating core with a gypsum fiberboard on one face of the insulating core and an oriented strand board on the second face of the insulating core. Preferably, the insulating core is comprised of a plastic foam such as expanded polystyrene or urethane that is bonded to both the gypsum fiberboard and the oriented strand board.

Porter (U.S. Pat. No. 6,588,172) describes the incorporation of a laminated layer of plastic impregnated paper into a SIP to increase the panel's tensile strength while rendering it impervious to moisture. This layer is typically situated between the gypsum board and plastic foam core, adhered through a conventional bonding agent.

Parker (U.S. Pat. No. 4,628,650) describes a SIP with a foam core with a layer having an overhang projecting from the foam core edges. The overhang is situated to facilitate an effective seal between adjacent SIPs, providing better thermal insulation. Additionally, the core of the panels has channels through the structure for the placement of joists, studs or rafters.

Clear (U.S. Pat. No. 6,079,175) describes a SIP of cementitious material for building structures. A lightweight fill material such as bottom ash, cement and water is poured between spaces of two outermost ribs, which is claimed to provide insulation, strength and also rigidity to the panel and therefore the structure the panel comprises. This SIP has the advantage of being constructed in remote or more barren areas as it is fairly inexpensive to create.

Pease (U.S. Pat. No. 6,725,616) prepares an insulated concrete wall either cast or built with blocks which is attached to reinforced insulated strips. The patentee indicates that users will require less time and labor in making insulated walls using the patentee's method of fixing reinforced rigid foam to the surface of a concrete wall.

Pease (U.S. Pat. No. 6,892,507) describes a method and apparatus for making an SIP with a rigid foam sheet. The rigid foam sheets have multiple grooves in which reinforcing strips are situated. The strips and rigid foam are then covered and bonded with a reinforcing sheet, the sheet providing both structural support and moisture retention.

Unfortunately, most panels claimed throughout the prior art are not effective against high heat or open flames, either combusting or experiencing significant charring. In addition, the prior art panels generally lack a high strength to density ratio, making them ill suited for applications where a lightweight, insulating, fire resistant yet strong panel is necessary for a building structure.

What is desired, therefore, is a composite panel which is of a low density, has desirable thermal insulating properties, and a high resistance to fire where the panel has a high strength and high strength to density ratio making the panel useful for structural applications including roofs, floors, doors, and walls. Indeed, a combination of characteristics, including strength to density ratios and compressive strength higher than contemplated in the prior art, as well as fire resistance and EMI shielding higher than contemplated in the prior art, have been found to be necessary for applications not limited to residential buildings, commercial buildings, aircraft or watercraft.

### SUMMARY OF THE INVENTION

The present invention provides a composite panel which is uniquely capable of being used in applications requiring a high strength to density ratio, and/or high resistance to combustion or charring, as well as EMI shielding. The inventive fire resistant panel exhibits a density, compressive strength and compressive strength to density ratio to provide a combination of strength and relatively light weight characteristics not heretofore seen. In addition, the carbon lattice of the carbon foam combined with the heat spreading layer resists both charring and combustion while maintaining structural integrity in other environmental conditions from high humidity to severely low temperatures, and the presence of the heat spreading layer permits the use of a thinner or lower density (and, hence, lighter weight) carbon foam than would otherwise be possible. Furthermore, the carbon foam can be produced in a desired size and configuration and can be readily machined for a specific size for a composite panel.

More particularly, the inventive panel has a carbon foam core with a density of from about 0.02 to about 0.6 grams per cubic centimeter (g/cc), with a strength to density ratio of about 300 to 10000 psi/(g/cc). A minimum strength to density ratio is needed to allow for sufficient handling, fabrication, and laminating of the foam in the panel, but strength to density ratios higher than about 10000 psi/(g/cc) provide little additional structural benefit.

The inventive composite panel should have the carbon foam core of a relatively uniform density both longitudinally and latitudinally for consistent thermal insulation and strength characteristics throughout the panel. Specifically, the carbon foam should have a relatively uniform distribution of pores in order to provide the required high compressive strength. Depending on the density of the foam, the pores can be relatively isotropic (by isotropic is meant that the aspect ratio of the pores, that is, the ratio of the largest diameter of the pore to the smallest diameter of the pore, is between about 1.0 and about 2.5, more preferably between about 1.0 and about 1.5; a perfectly spherical pore has an aspect ratio of 1.0). In addition, the carbon foam core should have a total porosity of about 65% to about 99%, more preferably about 70% to about 95% to create the optimal strength to density ratio of the panel.

The carbon foam core can be produced using foam derived from coal, coal tar pitch, mesophase pitch, and the like. Advantageously, the carbon foam core is produced from a polymeric foam block, particularly a phenolic foam block, that is carbonized in an inert or air-excluded atmosphere, at temperatures which can range from about 500° C., more preferably at least about 800° C., up to about 3200° C. to prepare the carbon foams for use in the inventive composite panel.

A heat spreading layer is included in the panel, which rapidly conducts heat from a localized source such as a fire across much of the panel. Ideally, the heat spreading layer is comprised of compressed particles of exfoliated graphite, sometimes known in the industry as flexible graphite sheet. The preferred compressed graphite heat spreader layer has an in-plane thermal conductivity of at least about 200 W/m-K, more preferably at least about 300 W/m-K.

The carbon foam core can be treated with a variety of coatings to improve the overall performance of the fire resistant panel. For example, an anti-oxidation coating can be applied to the carbon foam to increase its longevity in highly oxidative conditions. Additionally, a fire retardant coating, such as a coating containing intercalated, but unexfoliated, particles of graphite, can also be applied to the carbon foam core to further increase the fire resistance of the carbon foam core and thus the panel itself, when exposed to extreme temperatures. Such a coating is disclosed, for example, in U.S. Pat. Nos. 6,228,914 and 6,460,310, the disclosures of each of which are incorporated herein by reference.

In the preferred embodiment, the carbon foam core's first and second outer faces are covered with a layer as the totality of the panel is generally planar is design. Optionally, the layers may be comprised of oriented strand board (OSB) or one of a variety of gypsum boards. Additionally, one of the outer faces can be OSB while the other can be a gypsum board. Other materials suitable for use as the outer layers include a variety of thermoplastics, organic sheets, and fiber-reinforced composite boards.

The carbon foam core should be bound to the outer layers to construct the composite panels. Binding may be through the use of materials such as adhesives or cements which create a chemical interaction between the outer layers and the carbon foam core. These include binders specific to carbon foam applications as well as general cements, mastics or high temperature glue. Optionally, mechanical methods of combining the foam and outer layers can be used.

An object of the invention, therefore, is a composite panel having characteristics which enable it to be used as structural applications requiring a high strength to density ratio.

Another object of the invention is a composite panel, with the structure of the carbon foam core having a sufficiently high compressive strength to be used for high stress structural applications.

Still another object of the invention is a fire resistant composite panel where a heat spreading layer and a carbon foam core combine to provide a fire resistant barrier which is extremely resistant to both combustion and charring.

Yet another object of the invention is a structural insulated panel foam which can be produced in a desired size and configuration, where a carbon foam core can be machined or joined with other similar carbon foam sheets to provide larger structural carbon foam panels.

Another object of the invention is to provide a composite panel which is resistant to environmental stresses including high humidity and severe temperature fluctuations, and which can provide EMI shielding.

Still another object of the invention is to provide a panel whereby a carbon foam core provides adequate thermal insulation to maintain a temperature differential between a first surface of the panel and a second surface of the panel.

These aspects and others that will become apparent to the artisan upon review of the following description can be accomplished by providing a fire resistant composite panel with a heat spreading layer. The inventive composite panel has a carbon foam core with a density of from about 0.03 g/cc to about 0.6 g/cc, more preferably of from about 0.04 g/cc to about 0.16 g/cc, and a porosity of between about 65% and about 99%. Furthermore the thermal conductivity of the carbon foam core measured at room temperature is less than about 1.0 W/m-K, more preferably less than about 0.3 W/m-K, and most preferably from about 0.06 W/m-K to about 0.3 W/m-K.

One carbon foam material useful as the carbon foam core can be produced by carbonizing a polymer foam article, especially a phenolic foam, in an inert or air-excluded atmosphere. The phenolic foam precursor for the carbon foam core should preferably have a compressive strength of at least about 100 psi.

It is to be understood that both the foregoing general description and the following detailed description provide embodiments of the invention and are intended to provide an overview or framework of understanding to nature and character of the invention as it is claimed.

### BRIEF DESCRIPTION OF THE DRAWINGS

FIG. 1 is a view of a fire resistant composite panel with a carbon foam layer, two coating layers, two adhesive layers, and a first and second outer layer.

FIG. 2 is a cross sectional view of a fire resistant composite panel with a heat spreading layer and a carbon foam layer sandwiched between a first and second exterior layer.

FIG. 3 depicts a fire resistant composite panel with a heat spreading layer sandwiched between a first and second carbon foam layer.

FIG. 4 is a cross sectional view of a fire resistant composite panel with a heat spreading layer between a first and second carbon foam layer, all of which is sandwiched between a first and second outer layer.

### DETAILED DESCRIPTION OF THE PREFERRED EMBODIMENTS

Carbon foams in accordance with the carbon foam core of the present invention can be prepared from polymeric foams, such as polyurethane foams or phenolic foams, with phenolic foams being preferred. Phenolic resins are a large family of polymers and oligomers, comprised of a wide variety of structures based on the reaction products of phenols with formaldehyde. Phenolic resins are prepared by the reaction of phenol or substituted phenol with an aldehyde, especially formaldehyde, in the presence of an acidic or basic catalyst. Phenolic resin foam is a cured system comprised of open and closed cells. The resins are generally aqueous resoles catalyzed by sodium hydroxide at a formaldehyde:phenol ratio which can vary, but is preferably about 2:1. Free phenol and formaldehyde content should be low, although urea may be used as a formaldehyde scavenger.

The foam is prepared by adjusting the water content of the resin and adding a surfactant (e.g., an ethoxylated nonionic), a blowing agent (e.g., pentane, methylene chloride, or chlorofluorocarbon), and a catalyst (e.g., toluenesulfonic acid or phenolsulfonic acid). The sulfonic acid catalyzes the reaction, while the exotherm causes the blowing agent, emulsified in the resin, to evaporate and expand the foam. The surfactant controls the cell size as well as the ratio of open-to-closed cell units. Both batch and continuous processes are employed. In the continuous process, the machinery is similar to that used for continuous polyurethane foam. The properties of the foam depend mainly on density and the cell structure.

The preferred phenol is resorcinol, however, other phenols of the kind which are able to form condensation products with aldehydes can also be used. Such phenols include monohydric and polyhydric phenols, pyrocatechol, hydroquinone, alkyl substituted phenols, such as, for example, cresols or xylenols; polynuclear monohydric or polyhydric phenols, such as, for example, naphthols, p.p′-dihydroxydiphenyl dimethyl methane or hydroxyanthracenes.

The phenols used to make the foam starting material can also be used in admixture with non-phenolic compounds which are able to react with aldehydes in the same way as phenol.

The preferred aldehyde for use in the solution is formaldehyde. Other suitable aldehydes include those which will react with phenols in the same manner. These include, for example, acetaldehyde and benzaldehyde.

In general, the phenols and aldehydes which can be used in the process of the invention are those described in U.S. Pat. Nos. 3,960,761 and 5,047,225, the disclosures of which are incorporated herein by reference.

Optionally, the carbon foam core of the inventive composite panel can be created for an increased oxidation resistance by the specific inclusion of compounds solely for improving the oxidation resistance of the carbon foam. Such oxidation inhibiting additives include compounds of phosphorus and boron, including but not limited to the salts of ammonium phosphate, aluminum phosphate, zinc phosphate or boric acid, as well as the various condensed species of liquid polyphosphoric acid, and combinations thereof. An additional characteristic of the oxidation inhibiting additives is that the additives can be added during either the resin production stage or the phenolic foam forming stage of carbon foam production. Using either method, the final carbonization of the phenolic foam results in phosphorous or boron retained within the carbon foam structure that reduces the rate of oxidation of the carbon foam. Specifically, phosphorous or boron retained in the final carbon foam product from about 0.01% to about 0.5% by weight reduces the rate of oxidation by over 50%.

Alternatively, the carbon foam product can be treated with an oxidation-inhibiting agent after the completion of the carbonization process but prior to the integration in the panel. The preferred method would be to impregnate the carbon foam with polyphosphoric acid or aqueous solutions of phosphorous-containing materials such as ammonium phosphate, phosphoric acid, aluminum phosphate, or zinc phosphate, followed by a heat treatment to about 500° C. to simultaneously remove the water and fix the phosphorous to the carbon. Additionally, water-soluble boron compounds such as boric acid can be introduced in the above manner to create an oxidation-resistant carbon foam product.

The polymeric foam used as the starting material in the production of the carbon foam core should have an initial density which mirrors the desired final density for the carbon foam which is to be formed. In other words, the polymeric foam should have a density of about 0.03 g/cc to about 0.6 g/cc, more preferably about 0.05 g/cc to about 0.4 g/cc, most preferably about 0.05 g/cc to about 0.15 g/cc. The cell structure of the polymeric foam should be closed with a porosity of between about 65% and about 99% and a relatively high compressive strength, i.e., on the order of at least about 100 psi, and as high as about 300 psi or higher.

In order to convert the polymeric foam to carbon foam, the foam is carbonized by heating to a temperature of from about 500° C., more preferably at least about 800° C., up to about 3200° C., in an inert or air-excluded atmosphere, such as in the presence of nitrogen. The heating rate should be controlled such that the polymer foam is brought to the desired temperature over a period of several days, since the polymeric foam can shrink by as much as about 50% or more during carbonization. Care should be taken to ensure uniform heating of the polymer foam piece for effective carbonization.

By use of a polymeric foam heated in an inert or air-excluded environment, a non-graphitizing glassy carbon foam is obtained, which has the approximate density of the starting polymer foam, but a ratio of compressive strength to density of at least about 300 psi/(g/cc) up to 10000 psi/(g/cc).

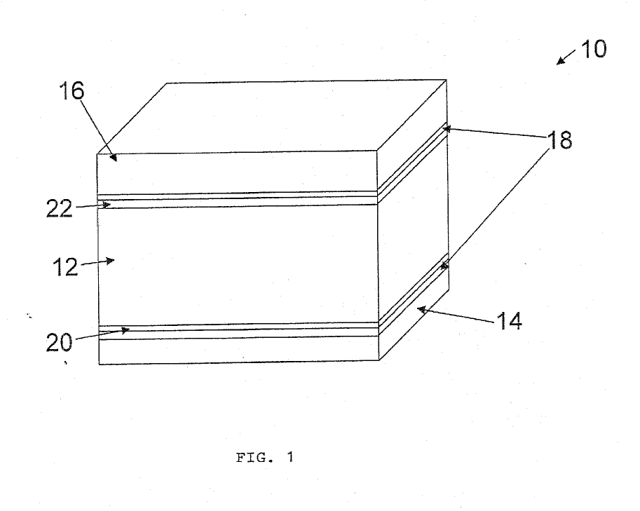

Referring now to FIG. 1, there is shown a partial side view of a composite panel 10 with a carbon foam core 12.

Carbon foam core 12 and panel 10 are generally planar, though they can be constructed to meet a variety of specifications. Optionally, carbon foam core 12 can be curved or possess rounded edges through either machining or molding to best fit the desired application.

Panel 10 includes both a first outer layer 14 and a outer layer 16 situated on opposite outer surfaces of carbon foam core 12. As with carbon foam core 12 and panel 10, both the first outer layer 14 and the second outer layer 16 can possess a variety of shapes for the desired application. The first outer layer 14 and the second outer layer 16 can comprise similar or different materials depending upon the specific structural application of the composite panel. These materials include typical construction materials such as plywood, oriented strand board, drywall, gypsum, cement composites, wood composites, or a variety of other rigid organic or inorganic construction boards. Furthermore, first outer layer 14 and second outer layer 16 can also be impregnations of the above materials or include thermoplastics, resins, carbon composites, ceramic composites or a variety of other artificially created materials.

In specific structural applications requiring substantial rigidity or abrasion resistance, a variety of metal compounds can be used to comprise both the first outer layer 14 and the second outer layer 16. In cases of aircraft construction these layers can include thin metal or composite skins around carbon foam core 12, or in the case of rigid watercraft, outer layer 14 and outer layer 16 can include hardened metal composites. The selection of first outer layer 14 and the second outer layer 16 can be based on the necessary tensile strength and fire resistant properties of the specific application for panel 10. Furthermore, first outer layer 14 and second outer layer 16 can be of two different materials where the use of panel 10 necessitates such properties. For example, in residential building structures the first outer layer 14 may be comprised of a thermoplastic which would be fairly impervious to environmental stresses while the second outer layer 16 can be gypsum board or an aesthetically pleasing paneling more visible to the interior of the residential building. Other materials which can comprise either one or both of the outer layers 14 and 16 include but are not limited to the following: paper, reinforced paper composites, oriented strand board, fiberboard, drywall, gypsum, gypsum composites, wood, wood composites, plywood, thermoplastics, plastic composites, resins, metals, metal alloys, metal composites, and combinations thereof.

The first outer layer 14 and the second outer layer 16 are connected to the carbon foam core 12 through a bonding or adhesive material 18. This bonding or adhesive material 18 can include chemical bonding agents suitable for specific applications ranging from high temperature conditions to exposure to an acidic environment. Different chemical bonding materials include adhesives, glues, cement, and mastic. Optionally, the first outer layer 14 and second outer layer 16 can be attached to the carbon foam core 12 through mechanical materials. While this method does affect the integrity and uniform characteristics of the carbon foam core 12, mechanical connects are available for little cost and are extremely quick to complete. Various mechanical attaching methods of attaching both the first outer layer 14 and the second outer layer 16 to the carbon foam core 12 include but are not limited to nails, studs, screws, braces, struts, fasteners, staples, and combinations thereof. Additionally, the first outer layer 14 and the second outer layer 16 can be compressedly bound to the carbon foam core through a series of high compression treatments of the outer layers 14 and 16 to the carbon foam core. While less permanent than either the mechanical or chemical attachment options, this type of attachment introduces no extra chemical compounds and it does not weaken the structural integrity of the carbon foam core 12, as does either the chemical or mechanical attachment methods.

Panel 10 can also include one or both of first coating 20 and second coating 22, which are applied to the carbon foam core 12 to alter the properties of carbon foam core 12. Specifically, first coating 20 and second coating 22 can be identical or different, depending upon the conditions and necessary properties of the carbon foam core 12, and can comprise materials such as a fire retardancy improvement coating to improve the fire retardant properties of the carbon foam core 12 or an oxidation resistant coating.

With a carbon foam core 12 as the insulating layer in a composite panel 10 such as an SIP, panel 10 has an inherent fire retardant/resistant property. Whereas other insulating materials merely preclude oxygen from an SIP's core structure, a carbon foam core 12 is itself resistant to combustion, and generates little or no smoke under fire conditions. Specifically, carbon foam core 12 is formed mainly of linked carbons with relatively few other elements present within its foam structure. As such, little material exists for combustion or smoke generation, other than that from the simple oxidation of the carbon foam core 12. For example, a carbon foam cores used in accordance with the present invention has been shown to have a smoke rating of zero under the fire conditions of the ASTM E-84 Tunnel Test, at all densities. In fact, for significant oxidation to occur, temperatures have to reach extremes, making a carbon foam core 12 very suitable for both commercial and residential structures where fire resistant structures are required.

Similarly, a carbon foam core 12 is resistant to many environmental stresses including insects, humidity, and heat. Carbon foam is an extremely hard substance, lending itself poorly to insect habitation while its chemical and structural properties are virtually not altered by a change in humidity. Furthermore, first outer layer 14 and second outer layer 16 can be selected for the specific environmental applications to which composite panel 10 will be subjected.

### Heat Spreading Layer and Fire Retardancy

The incorporation of a heat spreading layer into panel 10 greatly increases the fire retardancy of the resultant panel. As discussed previously, the primary means by which a fire is induced in a composite panel is through the delamination of an exterior surface, and the heating of panel material at the point of delamination to an auto-ignition temperature. The heat spreading layer of the present invention rapidly conducts heat from one location at the point of a fire and spreads this heat across the panel. This effectively acts to lower the temperature at any one location, and increases the time before a heat induced delamination of the outer surface occurs. In addition, the internal panel temperature increase is slower and more uniform, so this increases the time before the core begins to burn or oxidize. The heat spreading layer further serves to radiate or reflect heat from a fire back to the fire side of the panel, which decreases the temperature rise of the panel surface on the side with no fire.

Suitable materials for use as the heat spreader layer include pyrolytic graphite materials, such as those derived from the pyrolysis and subsequent graphitization of certain polymer films. However, these materials are not preferred, because they are cost-prohibitive, are only commercially available in single-layer thicknesses less than 0.15 mm, and are not available in sheet sizes sufficient to cover a panel surface in a continuous piece.

The most preferred materials useful as the heat spreader layer are sheets of compressed particles of exfoliated graphite, because of their anisotropic thermal properties. The compressed exfoliated graphite sheets are excellent conductors of heat along their length and width, but conduct heat much more slowly through the thickness of the sheet. This serves to spread the heat from the point of the fire across the surface of the panel. It also serves to reflect the heat back to the fire side of the panel, by not allowing the heat to pass through, and therefore limits the heat transferred through the panel to the opposite exterior surface, which is not exposed to a fire. Additionally, compressed exfoliated graphite is very resistant to chemical and thermal attack.

Suitable sheets of compressed particles of exfoliated graphite (often referred to in the industry as “flexible graphite”) can be produced by intercalating graphite flakes with a solution containing, e.g., a mixture of nitric and sulfuric acids, expanding or exfoliating the flakes by exposure to heat, and then compressing the exfoliated flakes to form coherent sheets. The production of sheets of compressed particles of exfoliated graphite is described in, for instance, U.S. Patent Application Publication No. US-2005-0079355-A1, the disclosure of which is incorporated herein by reference.

Graphite starting materials for the flexible sheets suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as graphite prepared by chemical vapor deposition, high temperature pyrolysis of polymers, or crystallization from molten metal solutions, and the like. Natural graphite is most preferred.

The graphite starting materials for the flexible sheets used in the present invention may contain non-graphite components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has an ash content of less than twenty weight percent. More preferably, the graphite employed for the present invention will have a purity of at least about 94%. In the most preferred embodiment, the graphite employed will have a purity of at least about 98%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 350 pph and more typically about 40 to about 160 pph. After the flakes are intercalated, any excess solution is drained from the flakes and the flakes are water-washed.

Alternatively, the quantity of the intercalation solution may be limited to between about 10 and about 40 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1,10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalated graphite flake with the organic reducing agent, the blend can be exposed to temperatures in the range of 25° to 125° C. to promote reaction of the reducing agent and intercalated graphite flake. The heating period is up to about 20 hours, with shorter heating periods, e.g., at least about 10 minutes, for higher temperatures in the above-noted range. Times of one-half hour or less, e.g., on the order of 10 to 25 minutes, can be employed at the higher temperatures.

The above described methods for intercalating and exfoliating graphite flake may beneficially be augmented by a pretreatment of the graphite flake at graphitization temperatures, i.e. temperatures in the range of about 3000° C. and above and by the inclusion in the intercalant of a lubricious additive.

The pretreatment, or annealing, of the graphite flake results in significantly increased expansion (i.e., increase in expansion volume of up to 300% or greater) when the flake is subsequently subjected to intercalation and exfoliation. Indeed, desirably, the increase in expansion is at least about 50%, as compared to similar processing without the annealing step. The temperatures employed for the annealing step should not be significantly below 3000° C., because temperatures even 100° C. lower result in substantially reduced expansion.

The annealing of the present invention is performed for a period of time sufficient to result in a flake having an enhanced degree of expansion upon intercalation and subsequent exfoliation. Typically the time required will be 1 hour or more, preferably 1 to 3 hours and will most advantageously proceed in an inert environment. For maximum beneficial results, the annealed graphite flake will also be subjected to other processes known in the art to enhance the degree expansion—namely intercalation in the presence of an organic reducing agent, an intercalation aid such as an organic acid, and a surfactant wash following intercalation. Moreover, for maximum beneficial results, the intercalation step may be repeated.

The annealing step of the instant invention may be performed in an induction furnace or other such apparatus as is known and appreciated in the art of graphitization; for the temperatures here employed, which are in the range of 3000° C., are at the high end of the range encountered in graphitization processes.

Because it has been observed that the worms produced using graphite subjected to pre-intercalation annealing can sometimes “clump” together, which can negatively impact area weight uniformity, an additive that assists in the formation of “free flowing” worms is highly desirable. The addition of a lubricious additive to the intercalation solution facilitates the more uniform distribution of the worms across the bed of a compression apparatus (such as the bed of a calender station conventionally used for compressing (or “calendering”) graphite worms into flexible graphite sheet. The resulting sheet therefore has higher area weight uniformity and greater tensile strength, even when the starting graphite particles are smaller than conventionally used. The lubricious additive is preferably a long chain hydrocarbon. Other organic compounds having long chain hydrocarbon groups, even if other functional groups are present, can also be employed.

More preferably, the lubricious additive is an oil, with a mineral oil being most preferred, especially considering the fact that mineral oils are less prone to rancidity and odors, which can be an important consideration for long term storage. It will be noted that certain of the expansion aids detailed above also meet the definition of a lubricious additive. When these materials are used as the expansion aid, it may not be necessary to include a separate lubricious additive in the intercalant.

The lubricious additive is present in the intercalant in an amount of at least about 1.4 pph, more preferably at least about 1.8 pph. Although the upper limit of the inclusion of lubricous additive is not as critical as the lower limit, there does not appear to be any significant additional advantage to including the lubricious additive at a level of greater than about 4 pph.

The thus treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compression molded together into flexible sheets that, unlike the original graphite flakes, can be formed and cut into various shapes, as hereinafter described.

Alternatively, the graphite sheets of the present invention may utilize particles of reground graphite sheets rather than freshly expanded worms, as disclosed in, e.g., U.S. Pat. No. 6,673,289, the disclosure of which is incorporated by reference herein. The sheets may be newly formed sheet material, recycled sheet material, scrap sheet material, or any other suitable source.

Graphite sheet and foil are coherent, with good handling strength, and are suitably compressed by, e.g. compression molding, to a thickness of about 0.025 mm to 3.75 mm and a typical density of about 0.1 to 1.5 grams per cubic centimeter (g/cc). Optionally, the graphite sheet may incorporate fibers and/or salts, or be impregnated with various resins to improve handling and durability. Additionally, reactive or non-reactive additives may be employed with the resin system to modify properties (such as tack, material flow, hydrophobicity, etc.). The graphite sheet can be processed to change the void condition of the sheet. By void condition is meant the percentage of the sheet represented by voids, which are typically found in the form of entrapped air. Generally, this is accomplished by the application of pressure to the sheet (which also has the effect of densifying the sheet) so as to reduce the level of voids in the sheet, for instance in a calender mill or platen press. Advantageously, the graphite sheet is densified to a density of at least about 1.3 g/cc (although impregnating with resin as discussed can reduce the voids without requiring densification to so high a level).

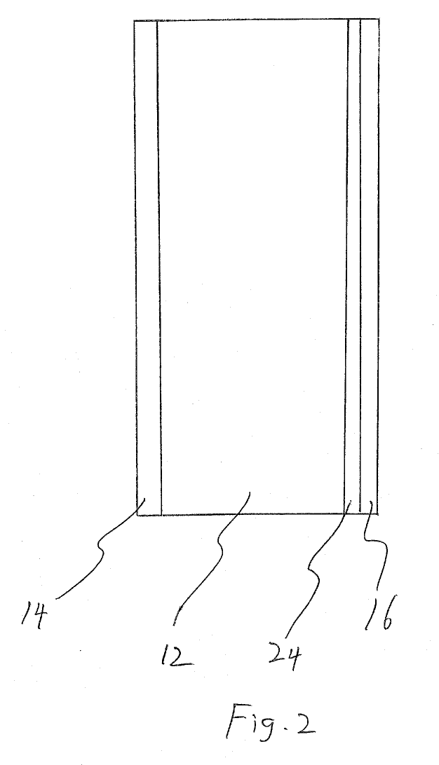

In one embodiment, as shown in FIG. 2, a heat spreading layer 24 is bound to the carbon foam core 12. The means of binding the various layers is discussed above. This heat spreading layer 24 can either be on one side or both sides of the carbon foam core 12 and can be in between any outer layers 14 and 16 and the carbon foam core 12.

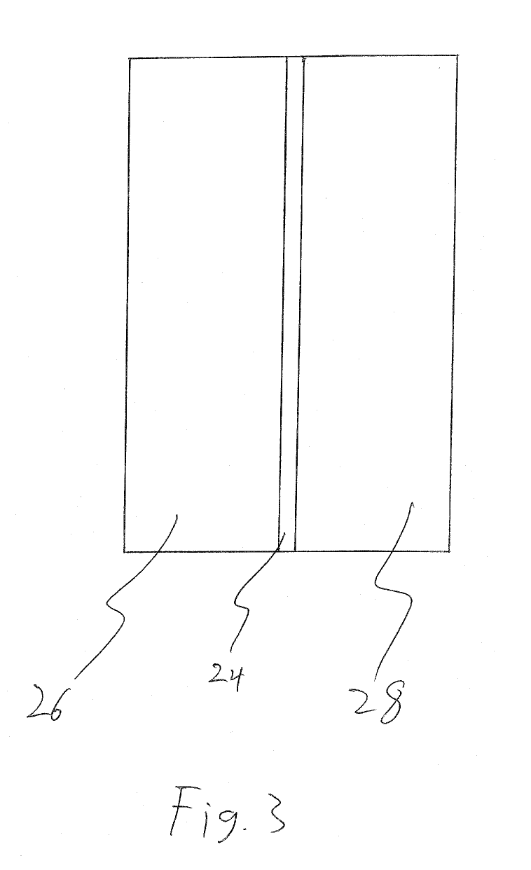

A second embodiment, as depicted in FIG. 3, has the heat spreading layer 24 sandwiched between a first and second layer of carbon foam material 26 and 28, respectively.

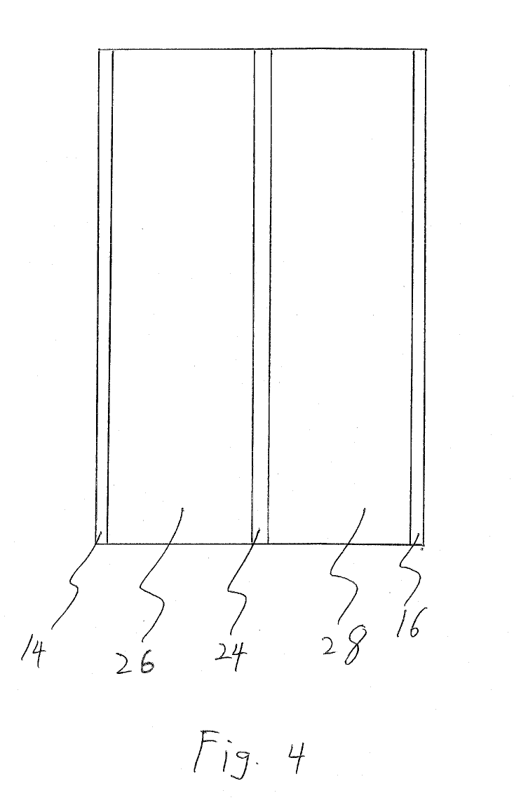

FIG. 4 depicts another embodiment wherein the heat spreading layer 24 is positioned between the first and second layers of carbon foam material 26 and 28, all of which are sandwiched between a first and second outer layer 14 and 16, respectively. Additional heat spreading layers 24 between either outer layer 14 or 16 and a carbon foam layer 26 or 28 can be included. The inclusion of the heat spreading layer 24 in between a first and second carbon foam layer 26 and 28 results in a fire retardant composite panel wherein, after the heat spreading layer 24, there is always at least an outer layer and a carbon foam layer on the cool side of the panel not exposed to fire.

The heat spreading capabilities of heat spreader layer 24 permit the use of a lower density carbon foam as carbon foam core 12, compared to constructions without a heat spreading layer. Using heat spreader layer 24 can alternately allow for a reduced thickness of the carbon foam layer while maintaining excellent fire resistance. Either approach provides weight and fire protection advantages over panels made without a heat spreading layer.

In one advantageous embodiment of the present invention, where the heat spreader 24 is attached as shown in FIG. 2, the carbon foam layer 12 preferably has a thickness of about 0.5 inch to about 6 inches, more preferably about 3 inches to about 4 inches. In the embodiments of FIGS. 3 and 4, the first and second carbon foam layers 26 and 28 can be of differing thickness, as long as the overall fire protection is maintained. Whether one or two carbon foam layers are used, the carbon foam should have a density of from about 0.04 g/cc to about 0.16 g/cc, and a ratio of compressive strength to density of from about 300 psi/(g/cc) to about 10,000 psi/(g/cc). Coatings of the type which improve fire resistance or increase resistance to oxidation, as discussed above, can be included on the single carbon foam layer 12 or on the first and second carbon foam layers 26 and 28, either between the heat spreading layer 24 and the foam, or between the heat spreading layer 24 and the outer layers 14 and 16.

Panel 10 and its superior strength to density ratio as well as fire retardancy makes it suitable for a wide variety of structural applications. Notably, composite panel 10 is quite useful in the construction of buildings where a lightweight yet strong material is desired where there are also mandates on fire retardant properties. Furthermore, inventive panel 10 possesses desirable thermal resistance thus helping maintain a controlled climate within the building. Also, panel 10 with its high compressive strength to density ratio is ideal for watercraft where lightweight and strong structures are required. Specifically, panel 10 can be used in aircraft carrier decks which are subjected to much compression yet must be as light as possible to maintain mobility of the watercraft. Furthermore, use of composite panel 10 as an aircraft carrier deck also instills an element of fire resistance directly into the deck paneling. An additional use of panel 10 can be in the construction of aircraft where a rigid and strong, yet lightweight material is useful.

The following examples are presented to further illustrate and explain the present invention and should not be viewed as limiting in any regard.

### Example I

Structural insulating panels prepared as described in Table I are prepared. Data is obtained for each panel using an air/propane torch, with the flame tip maintained approximately 3 inches from the panel surface. The time for the torch to burn completely through the construction is measured and set out in Table I.

TABLE I

| | Burn through time (minutes) for various | | |
|---|---|---|---|
| | carbon foam densities | | |
| Description | 0.032 g/cc | 0.080 g/cc | 0.16 g/cc |
| 1-inch thick foam | 13 | 27 | 27 |
| 2-inch thick foam | 35 | not measured | not measured |
| 1-inch thick foam | >60 | >60 | not measured |
| with single heat | | | |
| spreader layer | | | |
| 1-inch foam on | >60 | >60 | not measured |
| both sides of head | | | |
| spreader layer | | | |

The results shown in Table I show the improvement in fire resistance when a heat spreading layer is used in conjunction with a carbon foam core. Whereas 1-inch thick samples of foam of any density burn through relatively quickly, even the lowest density foam survives for greater than one hour when it is combined with the inventive heat spreading layer.

### Example II

In a large scale fire test carried out using heat spreader 24 on either side of a 3.5-inch carbon foam core 12 combined with an outer layer 16 of type X gypsum board, the panel achieves an ASTM E-119 fire rating of at least about 2 hours.

The incorporation of heat spreading layers, especially heat spreading layers of compressed particles of exfoliated graphite, produces a composite panel having improved fire resistance. The anisotropic thermal properties of the compressed exfoliated graphite sheet provide a uniquely adapted heat spreading layer. The very temperature stable carbon foam used in conjunction with the heat spreading layer provides a panel with exceptional fire retardant capabilities. The fire retardancy combined with the strength of the inventive panel provides a significantly improved product for a wide variety of uses.

Accordingly, by the practice of the present invention, composite panels with carbon foam cores and heat spreading layers, having heretofore unrecognized characteristics, are prepared. These panels exhibit exceptionally high compressive strength to density ratios, much improved fire resistance and environmental stability, as well as EMI shielding, making them uniquely effective at structural applications, ranging from residential construction to aircraft and watercraft structural units.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A fire resistant composite panel comprising:
a first layer of a carbon foam material; and
a heat spreader layer bound to the carbon foam material.

2. The panel of claim 1, wherein the heat spreader layer comprises compressed particles of exfoliated graphite.

3. The panel of claim 1, further comprising:
a second layer of carbon foam material positioned such that the heat spreader layer is sandwiched between the first and second layers of carbon foam material.

4. The panel of claim 3, wherein each of the first and second layers of carbon foam material has a thickness of at least about 0.25 inch.

5. The panel of claim 4, wherein the thicknesses of the first and second layers of carbon foam material are substantially equal.

6. The panel of claim 3, wherein each of the first and second layers of carbon foam material has a thickness in a range of up to about 2.0 inches.

7. The panel of claim 2, wherein when the carbon foam material has a thickness of less than about 4.0 inches, the panel exhibits a fire rating of at least two hours.

8. The panel of claim 1, wherein the carbon foam material has a density of from about 0.03 g/cc to about 0.6 g/cc.

9. The panel of claim 1, wherein the carbon foam material has a density of from about 0.04 g/cc to about 0.16 g/cc.

10. The panel of claim 1 wherein the carbon foam material has a thermal conductivity measured at room temperature (add to spec as well Done: DWK) of less than about 1 W/m-K.

11. The panel of claim 1, further comprising first and second outer layers having the first layer of carbon foam material and the heat spreader layer sandwiched therebetween.

12. The panel of claim 11, wherein the outer layers are each selected from the group consisting of paper, reinforced paper composites, oriented strand board, fiberboard, drywall, gypsum, gypsum composites, wood, wood composites, plywood, thermoplastics, plastic composites, resins, metals, metal alloys, metal composites, and combinations thereof.

13. A composite panel comprising:
first and second outer layers;
first and second layers of carbon foam material sandwiched between the first and second outer layers; and
a heat spreader layer of compressed particles of exfoliated graphite sandwiched between the first and second layers of carbon foam material.

14. The panel of claim 13, wherein each of the first and second layers of carbon foam material has a thickness of at least about 0.25 inch to about 3.0 inches.

15. The panel of claim 14, wherein when the first and second layers of carbon foam material have a combined thickness of at least about 4.0 inches, the panel exhibits a fire rating of at least two hours.

16. The panel of claim 13, wherein the carbon foam material includes first and second layers of coating disposed between the first and second carbon foam layers and the first and second outer layers, respectively.

17. The panel of claim 16, wherein the first and second layers of coating improve fire retardancy of the carbon foam material.

18. The panel of claim 13, wherein the carbon foam material has a thermal conductivity measured at room temperature of less than about 1.0 W/m-K.
